(19) United States
(12) Patent Application Publication
(10) Pub. No.: US 2020/0023761 A1
(43) Pub. Date: Jan. 23, 2020

(54) TABLE DEVICE

(71) Applicant: TOYOTA BOSHOKU KABUSHIKI KAISHA, Aichi-ken (JP)

(72) Inventors: Seiya NISHIMURA, Aichi-ken (JP); Fumitoshi AKAIKE, Aichi-ken (JP)

(73) Assignee: TOYOTA BOSHOKU KABUSHIKI KAISHA, Aichi-ken (JP)

(21) Appl. No.: 16/511,519

(22) Filed: Jul. 15, 2019

(30) Foreign Application Priority Data
Jul. 17, 2018 (JP) 2018-134140
Jul. 17, 2018 (JP) 2018-134141
Jul. 17, 2018 (JP) 2018-134143

(51) Int. Cl. B60N 3/00; A47B 1/10; A47B 13/08; A47B 9/00

(52) U.S. Cl. CPC B60N 3/001; A47B 9/00; A47B 13/081; A47B 1/10

(57) ABSTRACT

A table device including: a plurality of flat plate portions configured to form a table surface and including a first flat plate portion and a second flat plate portion; and a flat plate support mechanism supporting the first flat plate portion and the second flat plate portion in a horizontal state so that the first flat plate portion and the second flat plate portion are capable of forming a continuous table surface, wherein the flat plate support mechanism includes a raising and lowering mechanism configured to support the first flat plate portion and the second flat plate portion so that the first flat plate portion and the second flat plate portion in the horizontal state are movable relative to each other in a height direction.

### CROSS-REFERENCE TO RELATED APPLICATIONS

This application claims priority from Japanese Patent Application No. 2018-134140 filed on Jul. 17, 2018, Japanese Patent Application No. 2018-134141 filed on Jul. 17, 2018, and Japanese Patent Application No. 2018-134143 filed on Jul. 17, 2018, the entire contents of which are incorporated herein by reference.

### TECHNICAL FIELD

The present disclosure relates to a table device configured to form a table surface by a plurality of flat plate portions.

### BACKGROUND ART

JP-A-2005-75148 describes a technique related to a table device which forms a table surface by a flat plate portion. The table device in JP-A-2005-75148 is a table configured to be storable on a back surface of a seat back of a vehicle seat, and is used in a rear seat. The table device includes a fixed rail connected to the back surface of the seat back in a vertically rotatable manner by a hinge, a movable rail connected to the fixed rail in a front-rear slidable manner, and a table portion having a flat plate shape attached to the movable rail. In a case of using the table device, the fixed rail is rotated downward from a stored position along the back surface of the seat back to a substantially horizontal use position, and the movable rail is slid to a front side with respect to the fixed rail. As a result, an upper surface of the table portion can be used as a table surface.

JP-A-2008-155666 describes a technique related to a table device which forms a table surface by a flat plate portion. The table device in JP-A-2008-155666 is a table used on a back surface of a seat back folded so as to overlap a seat cushion from above. That is, the table device includes a table having a flat plate shape, and an end edge of the table is attached to the back surface of the seat back by a hinge. Further, the table is configured to be rotatable about 180° between a stored position along the back surface of the seat back and a use position protruding from the seat back by the hinge.

The table device described in JP-A-2005-75148 is configured such that the fixed rail is rotated downward from the stored position along the back surface of the seat back to the substantially horizontal use position by the hinge, and the movable rail and the table portion are supported at the use position by the fixed rail. Therefore, the table portion cannot be raised and lowered at the use position. Even when the table device includes a plurality of sets of table portions, movable rails, and fixed rails, height positions of some of the table portions cannot be changed with respect to the other table portions. Therefore, a degree of freedom when using the table is low.

The table device described in JP-A-2005-75148 is configured such that the movable rail is slid with respect to the fixed rail to horizontally move the table portion. Therefore, the table portion cannot be horizontally moved in any direction, and the degree of freedom when using the table is low.

The table device described in JP-A-2008-155666 is configured such that the table can be rotated about 180° between the stored position and the use position by the hinge. For example, the table cannot be held at an intermediate position between the stored position and the use position. Therefore, it is difficult to use the table in a tilted state or to adjust a tilt angle of the table.

### SUMMARY

An aspect of the present disclosure provides a table device in which a usability thereof can be improved by individually changing height positions of a plurality of flat plate portions configured to form a table surface.

Another aspect of the present disclosure provides a table device in which a usability thereof can be improved by horizontally moving a plurality of flat plate portions configured to form a table surface in any direction.

Another aspect of the present disclosure provides a table device in which a usability thereof can be improved by adjusting a tilt angle of a flat plate portion.

According to an aspect of the present disclosure, there is provided a table device including: a plurality of flat plate portions configured to form a table surface and including a first flat plate portion and a second flat plate portion; and a flat plate support mechanism supporting the first flat plate portion and the second flat plate portion in a horizontal state so that the first flat plate portion and the second flat plate portion are capable of forming a continuous table surface, wherein the flat plate support mechanism includes a raising and lowering mechanism configured to support the first flat plate portion and the second flat plate portion so that the first flat plate portion and the second flat plate portion in the horizontal state are movable relative to each other in a height direction.

Accordingly, the first flat plate portion and the second flat plate portion are movable in the height direction in the horizontal state by an action of the raising and lowering mechanism of the flat plate support mechanism. Therefore, for example, in a state in which the first flat plate portion is used as a table, the second flat plate portion can be used as a shelf or the like. That is, since the height positions of the plurality of flat plate portions forming the table surface can be changed individually, the usability of the table device is improved.

According to another aspect of the present disclosure, there is provided a table device including: a plurality of flat plate portions configured to form a table surface and including a first flat plate portion and a second flat plate portion; and a flat plate support mechanism supporting the first flat plate portion and the second flat plate portion in a horizontal state so that the first flat plate portion and the second flat plate portion are capable of forming a continuous table surface, wherein the flat plate support mechanism includes a horizontal movement mechanism configured to support the first flat plate portion so that the first plate portion is horizontally movable with respect to the second flat plate portion in any direction in the horizontal state.

Accordingly, the first flat plate portion is horizontally movable with respect to the second flat plate portion in any direction in the horizontal state by an action of the horizontal movement mechanism of the flat plate support mechanism. Therefore, a shape of the table surface formed by the first flat plate portion and the second flat plate portion can be changed to various shapes. Therefore, the usability of the table device is improved.

According to another aspect of the present disclosure, there is provided a table device including: a plurality of flat plate portions configured to form a table surface and including a first flat plate portion and a second flat plate portion; and a flat plate support mechanism configured to support the first flat plate portion and the second flat plate portion in a horizontal state so that the first flat plate portion and the second flat plate portion are capable of forming a continuous table surface, wherein the flat plate support mechanism includes an angle adjustment mechanism configured to support the first flat plate portion and the second flat plate portion so that tilt angles of the first flat plate portion and the second flat plate portion with respect to a horizontal plane are capable of being individually adjusted.

Accordingly, the first flat plate portion and the second flat plate portion are capable of individually adjusting the tilt angles thereof with respect to the horizontal plane by an action of the angle adjustment mechanism of the flat plate support mechanism. Therefore, for example, the first flat plate portion and the second flat plate portion can be folded so as to overlap each other. In addition, in a state in which one of the first flat plate portion and the second flat plate portion is held horizontally, it is also possible to use the other one by tilting the same. Therefore, the usability of the table device is improved.

### BRIEF DESCRIPTION OF DRAWINGS

FIG. 1 is a schematic perspective view of a vehicle including a table device according to a first embodiment of the present disclosure;

FIG. 2 is perspective view showing a folded state of the table device:

FIG. 3 is a perspective view showing a state in which the table device is used as an assembly table;

FIG. 4 is a schematic side view of a monitor support mechanism in the folded state of the table device;

FIG. 5 is a plan view showing a stage before using the table device as the assembly table, and a schematic plan view of an individual operation mechanism in the monitor support mechanism;

FIG. 6 is a side view of the individual operation mechanism before using the table device as the assembly table;

FIG. 7 is a plan view showing a state in which the table device is used as the assembly table, and a schematic plan view of the individual operation mechanism:

FIG. 8 is a side view of the individual operation mechanism in the state in which the table device is used as the assembly table:

FIG. 9 is a schematic perspective view when the table device is used as a stepped table;

FIG. 10 is a side view of the individual operation mechanism in a state in which the table device is used as the stepped table;

FIG. 11 is a schematic perspective view when the table device is used as a stepped table having different patterns:

FIG. 12 is a side view of the individual operation mechanism in a state in which the table device is used as the stepped table having different patterns;

FIG. 13 is a plan view showing a state in which the table device is used as a divided table, and a schematic plan view of the individual operation mechanism;

FIG. 14 is a side view of an individual operation mechanism in a state in which a table device according to a modified example is used as an assembly table;

FIG. 15 is a side view of the individual operation mechanism in a state in which the table device according to the modified example is used as a divided table:

FIG. 16 is a side view of an individual operation mechanism in a state in which a table device according to a second embodiment is used as an assembly table:

FIG. 17 is a side view of the individual operation mechanism in a state in which the table device according to the second embodiment is used as a divided table;

FIG. 18 is a side view of an individual operation mechanism in a state in which a table device according to a third embodiment is used as an assembly table;

FIG. 19 is a side view of the individual operation mechanism in a state in which the table device according to the third embodiment is used as a divided table;

FIG. 20 is a side view of an individual operation mechanism in a state in which a table device according to a fourth embodiment is used as an assembly table:

FIG. 21 is a side view of the individual operation mechanism in a state in which the table device according to the fourth embodiment is used as a divided table;

FIG. 22 is a side view of the individual operation mechanism in a state in which the table device according to the fourth embodiment is used for a table and a monitor:

FIG. 23 is a schematic perspective view of a state in which the table device according to the fourth embodiment is used for the table and the monitor;

FIG. 24 is a side view of an individual operation mechanism in a state in which a table device according to a fifth embodiment is used as an assembly table:

FIG. 25 is a side view of the individual operation mechanism in a state in which the table device according to the fifth embodiment is used as a divided table;

FIG. 26 is a side view of an individual operation mechanism in a state in which a table device according to a sixth embodiment is used as an assembly table:

FIG. 27 is a side view of the individual operation mechanism in a state in which the table device according to the sixth embodiment is used as a divided table:

FIG. 28 is a side view of an individual operation mechanism in a state in which a table device according to a seventh embodiment is used as an assembly table:

FIG. 29 is a side view of the individual operation mechanism in a state in which the table device according to the seventh embodiment is used as a divided table;

FIG. 30 is a side view of the individual operation mechanism in a state in which the table device according to the seventh embodiment is used for a table and a monitor;

FIG. 31 is a schematic perspective view of a state in which the table device according to the seventh embodiment is used for the table and the monitor;

FIG. 32 is a side view of an individual operation mechanism in a state in which a table device according to an eighth embodiment is used as an assembly table; and

FIG. 33 is a side view of the individual operation mechanism in a state in which the table device according to the eighth embodiment is used as a divided table.

### DETAILED DESCRIPTION

### First Embodiment

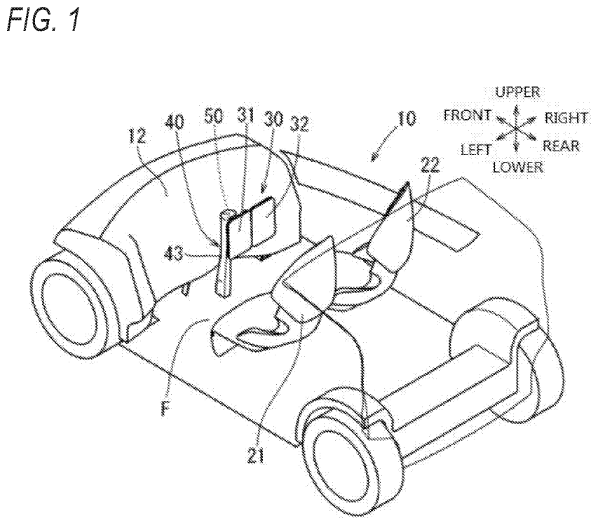

Hereinafter, a table device of a vehicle according to a first embodiment of the present disclosure will be described with reference to FIGS. 1 to 15. A table device 30 according to the present embodiment is a table device 30 using a quadrangular plate-shaped monitor used in the vehicle. Here, front, rear, left, right, upper and lower directions shown in the drawings correspond to front, rear, left, right, upper and lower directions of the vehicle including the table device 30.

<Overview of Vehicle 10>

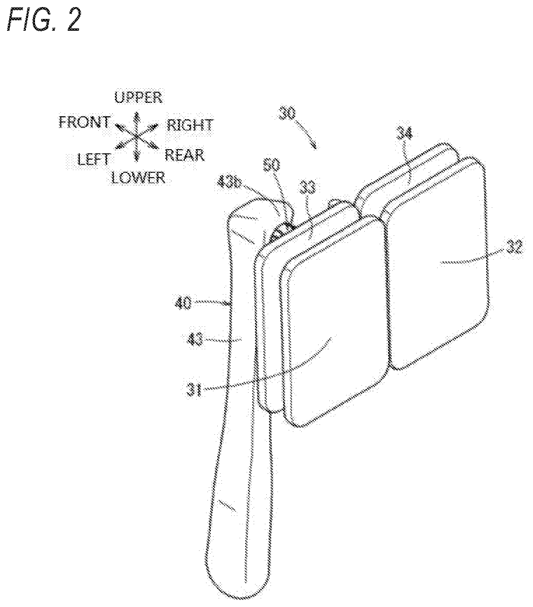

A vehicle 10 is a vehicle capable of autonomous driving. As shown in FIG. 1, in the vehicle 10, for example, a computer (not shown) for performing an autonomous driving operation and other control operations of the vehicle 10 is installed in a dashboard 12 provided on a front portion of a vehicle interior. Left and right seats 21, 22 are installed in the vehicle interior, and a seat moving device (not shown) including a front-rear slide mechanism, a raising and lowering mechanism, a rotation mechanism or the like is provided on a lower side of each of the seats 21, 22. In addition, as shown in FIGS. 1 and 2, the table device 30 in a state of being folded at a center position in a vehicle width direction is erected in front of the left and right seats 21, 22. Here, in FIG. 1, a windshield, a front roof panel, left and right doors, or the like configuring the vehicle interior are omitted.

<Table Device 30>

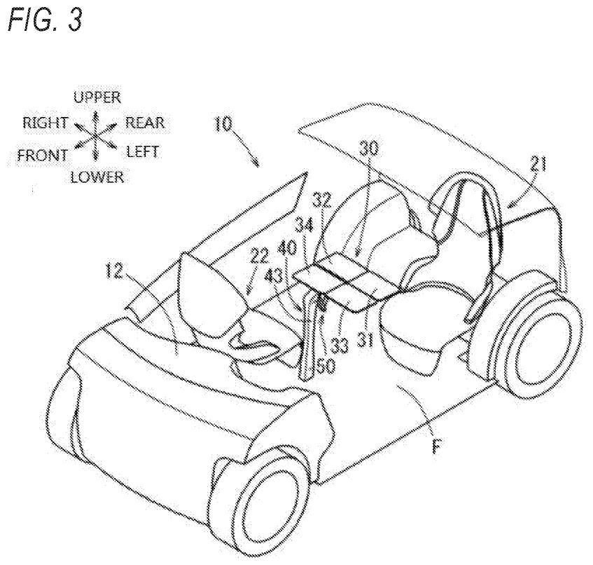

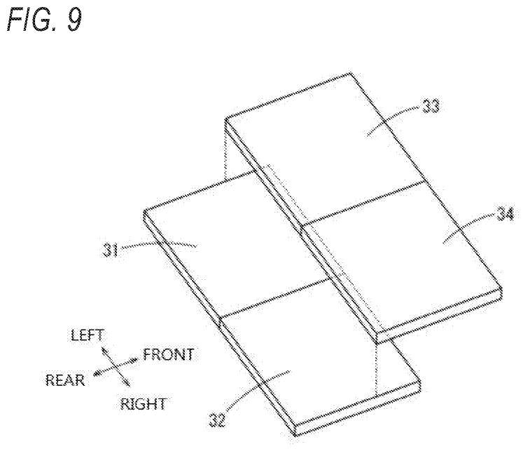

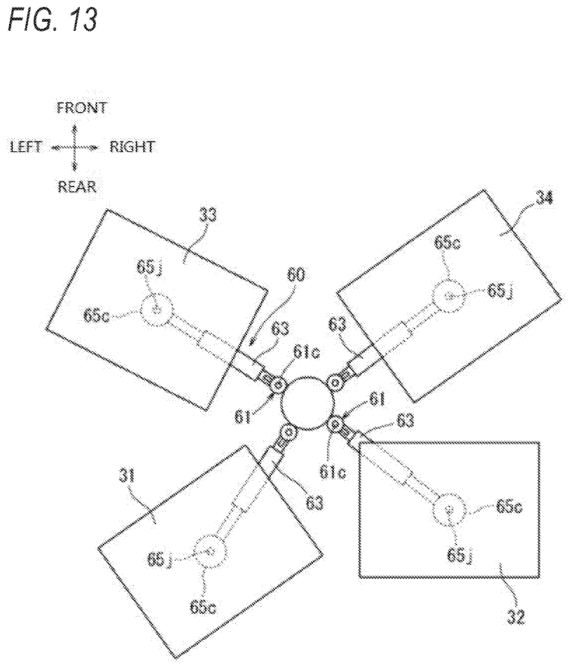

The table device 30 is configured such that four monitors 31 to 34 in a folded state as shown in FIG. 2 can be deployed and used in an assembly table (see FIG. 3 or the like), a stepped table (see FIG. 9), or a divided table (see FIG. 13 or the like). The table device 30 includes first to fourth monitors 31 to 34, and a monitor support mechanism 40 configured to movably support the monitors 31 to 34. The first to fourth monitors 31 to 34 of the table device 30 are configured to be able to transmit and receive signals to and from the computer. Further, the computer operates based on input signals from the dashboard 12, the first to fourth monitors 31 to 34 or the like, and the monitor support mechanism 40 operates, so that the first to fourth monitors 31 to 34 are moved according to the use.

<Monitor Support Mechanism 40>

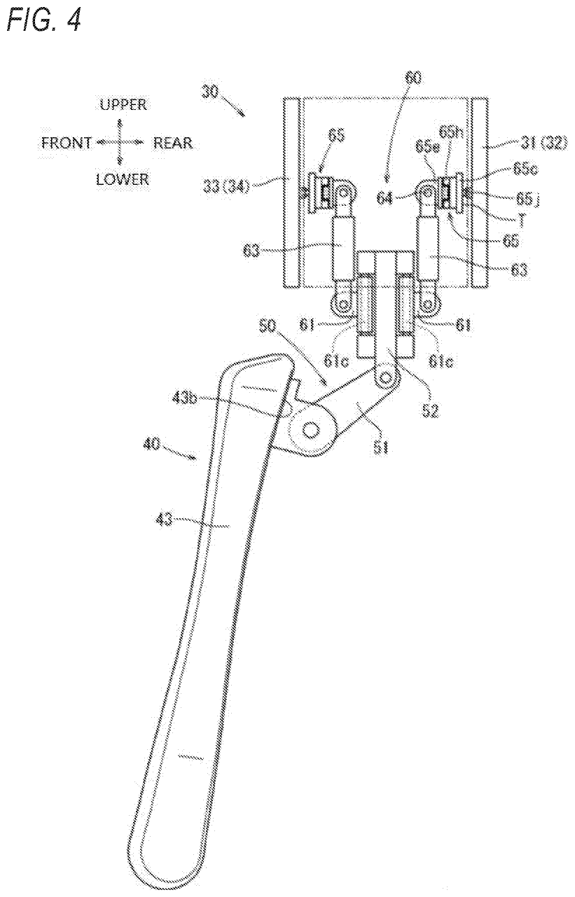

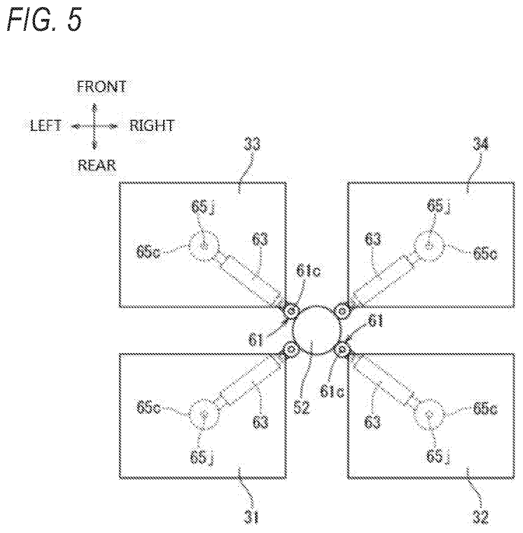

As shown in FIGS. 4, 5 or the like, the monitor support mechanism 40 includes a support post 43, a link portion 50, and four sets of individual operation mechanisms 60. As shown in FIGS. 1, 2 or the like, the support post 43 is erected on a floor surface F in the vehicle interior, and is provided with a support post tilt mechanism (not shown) configured to tilt the support post 43 at a predetermined angle in 360° direction from a position in which the support post 43 stands up vertically with respect to the floor surface F under the floor. Accordingly, for example, the four monitors 31 to 34 can be moved in a left-right direction by tilting the support post 43 in the left-right direction from an original position shown in FIG. 1. The monitors 31 to 34 can be moved in a front-rear direction by tilting the support post 43 in the front-rear direction from the original position. Further, it is also possible to adjust positions of the monitors 31 to 34 by tilting the support post 43 in an oblique direction from the original position.

The link portion 50 of the monitor support mechanism 40 is a portion which collectively changes postures or the like of the first to fourth monitors 31 to 34 according to the use of the monitors 31 to 34. As shown in FIG. 4, the link portion 50 includes a link body portion 51 and a columnar portion 52. In the link body portion 51 of the link portion 50, a base end portion of the link body portion 51 is connected to a tip end portion rear surface 43b of the support post 43 in a vertically rotatable manner. In the columnar portion 52, a base end portion of the columnar portion 52 is connected to a tip end of the link body portion 51 in a vertically rotatable manner. As a result, the columnar portion 52 can be raised and lowered by vertically rotating the link body portion 51 with respect to the support post 43. In addition, the postures or the like of the first to fourth monitors 31 to 34 can be collectively adjusted by adjusting a vertical rotation angle of the columnar portion 52 with respect to the link body portion 51. Here, the vertical rotation or the like of the link body portion 51 and the columnar portion 52 of the link portion 50 is performed using a driving force such as a motor (not shown).

As shown in FIGS. 4, 5 or the like, four support shafts 61c are fixed to a periphery of the columnar portion 52 of the link portion 50 at equal intervals in a peripheral direction so as to be parallel to an axis of the columnar portion 52. Rotation brackets 61 of the individual operation mechanisms 60 are connected to the respective support shafts 61c so as to be rotatable around axes of the support shafts 61c, respectively.

<Individual Operation Mechanisms 60>

The individual operation mechanisms 60 are provided corresponding to the first to fourth monitors 31 to 34, and are configured to move the first to fourth monitors 31 to 34 in any direction. That is, as shown in FIG. 4 or the like, each of the individual operation mechanisms 60 includes the above-described rotation bracket 61, an arm 63, and a monitor side connection portion 65. The arm 63 is, for example, a rod-shaped member capable of adjusting a length in an axial direction by using a screwing action between a male screw and a female screw, and a base end portion side thereof is connected to the rotation bracket 61 in a vertically rotatable manner. In addition, a tip end side of the arm 63 is connected to the monitor side connection portion 65 in a vertically rotatable manner.

As shown in FIG. 4 or the like, each of the monitor side connection portion 65 includes a base portion 65e to which the arm 63 is connected in a vertically rotatable manner, a hinge portion 65h, and a monitor rotation portion 65c. The hinge portion 65h of the monitor side connection portion 65 is a portion which connects the base portion 65e and the monitor rotation portion 65c in a rotatable manner around a hinge axis (not shown), and the hinge axis is provided so as to be orthogonal to a connection shaft 64 between the arm 63 and the base portion 65e. That is, the monitor rotation portion 65c of the monitor side connection portion 65 is rotatable in a direction perpendicular to a rotation direction of the base portion 65e with respect to the arm 63.

As shown in FIG. 4, the monitor rotation portion 65c of the monitor side connection portion 65 includes an opposing surface T parallel to the corresponding one of back surfaces of the first to fourth monitors 31 to 34, and a rotation shaft 65j is provided perpendicular to the opposing surface T thereof. The rotation shaft 65j of the monitor rotation portion 65c is provided so as to be orthogonal to the connection shaft 64 and the hinge axis, and connected to a center of each of the back surfaces of the corresponding first to fourth monitors 31 to 34. Therefore, each of the first to fourth monitors 31 to 34 can rotate along a monitor surface by rotating the rotation shaft 65j of the monitor rotation portion 65c.

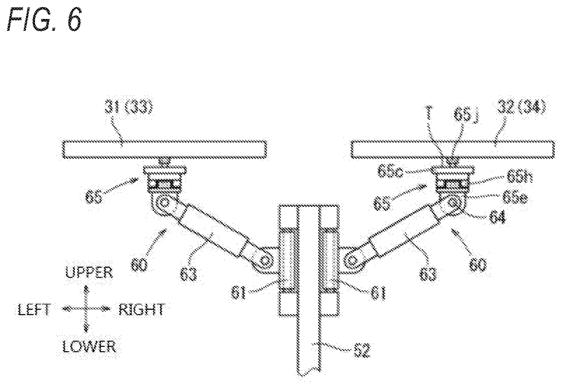

According to the above configuration, as shown in FIG. 6 or the like, the individual operation mechanisms 60 can adjust height positions and horizontal positions of the corresponding first to fourth monitors 31 to 34 by rotating the arms 63 vertically with respect to the rotation brackets 61. In addition, by rotating the base portions 65e of the monitor side connection portions 65 in an opposite direction in synchronization with the vertical rotation of the arms 63, tilt of the corresponding first to fourth monitors 31 to 34 can be held at a constant angle (for example, horizontal). That is, when the arms 63 are rotated vertically with respect to the rotation brackets 61, the base portions 65e of the monitor side connection portions 65 is rotated vertically in the opposite direction with respect to the arms 63, so that the corresponding first to fourth monitors 31 to 34 can be held horizontally, for example.

As shown in FIG. 5 or the like, an orientation of each of the arms 63 in the horizontal direction can be adjusted by rotating the rotation bracket 61 horizontally around the axis of the support shaft 61c of the columnar portion 52 of the link portion 50. In addition, the corresponding first to fourth monitors 31 to 34 can be tilted in a width direction (radial direction) of the arms 63 by rotating the monitor rotation portions 65c around the hinge axes with respect to the base portions 65e of the monitor side connection portions 65. Further, the corresponding first to fourth monitors 31 to 34 can be rotated along the monitor surfaces by rotating the rotation shafts 65j of the monitor rotation portions 65c.

Here, the vertical rotation of the arm 63 with respect to the rotation bracket 61, the vertical rotation of the base portion 65e of the monitor side connection portion 65 with respect to the arm 63, and extension and contraction of the arm 63 are performed using a driving force such as a motor (not shown). The horizontal rotation of the rotation bracket 61 with respect to the support shaft 61c of the columnar portion 52, the rotation of the hinge portion 65h of the monitor side connection portion 65, and the rotation of the rotation shaft 65j of the monitor rotation portion 65c are similarly performed using a driving force such as a motor (not shown).

<Use Mode (Assembly Table) of Table Device 30>

As shown in FIG. 3 or the like, in a case where the table device 30 is used as the assembly table, for example, a display portion (not shown) in a table mode displayed on the dashboard 12 or the monitors 31 to 34 is operated. As a result, a predetermined motor or the like of the monitor support mechanism 40 is driven, and as shown in FIGS. 1 and 2, the support post 43 of the table device 30 in the original position are tilted, and the monitors 31 to 34 in the folded state are disposed at a center position of the vehicle interior. As shown in FIG. 4, the link body portion 51 and the columnar portion 52 of the link portion 50 of the monitor support mechanism 40 are operated to adjust the monitors 31 to 34 to a predetermined height position. At this time, the columnar portion 52 of the link portion 50 is substantially upright.

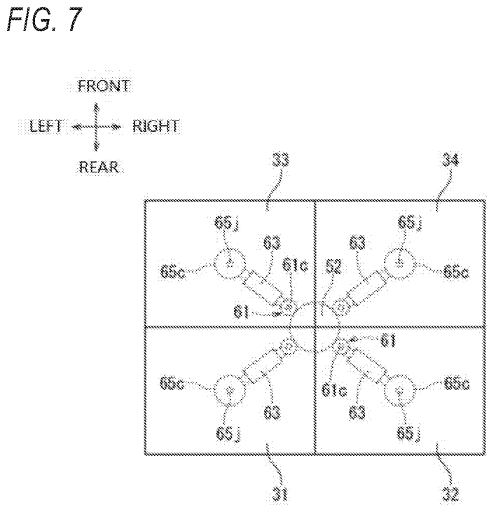

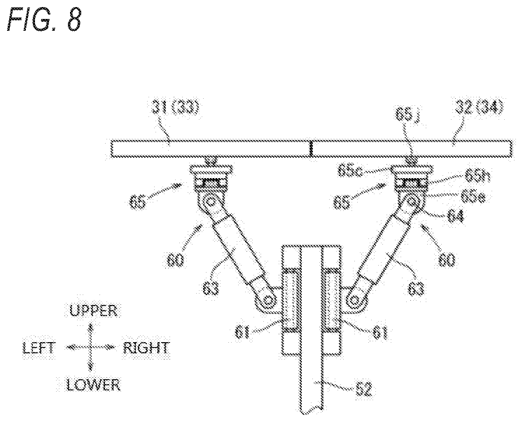

Next, as shown in FIG. 5, the rotation bracket 61 of each of the individual operation mechanisms 60 horizontally rotates around the axis of the support shaft 61c of the columnar portion 52, so that the arm 63 is directed radially outward of the columnar portion 52. Subsequently, each of the arms 63 rotates downward in a fall-down direction with respect to the rotation bracket 61 from a state shown in FIG. 4, and further, the monitor side connection portions 65 rotates in a direction to make the first to fourth monitors 31 to 34 horizontal with respect to the arms 63. As a result, as shown in FIGS. 5 and 6, the first to fourth monitors 31 to 34 held horizontally are disposed at a predetermined gap. As shown in FIGS. 7 and 8, in the state in which the first to fourth monitors 31 to 34 are horizontally held, by rotating the arms 63 upward by a predetermined angle, the first to fourth monitors 31 to 34 come close to each other, and the monitor surfaces of the first to fourth monitors 31 to 34 become continuous. As a result, the table device 30 becomes the assembly table having the monitor surfaces as a table surface.

<Stepped Table>

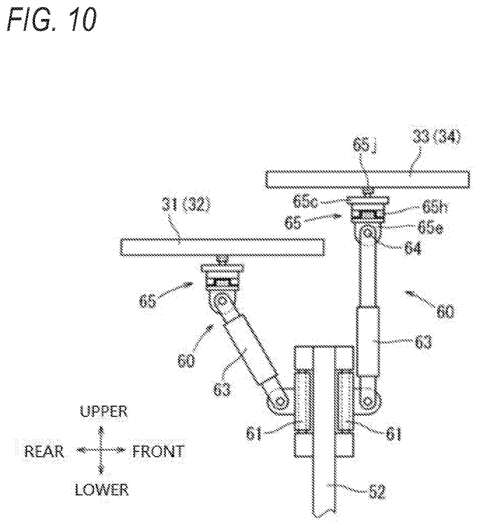

As shown in FIGS. 9 and 10, in a case where the table device 30 is used as a stepped table, for example, the arms 63 or the like of the individual operation mechanisms 60 operate as follows. That is, from the state of the assembly table (see FIG. 8), the arms 63 corresponding to the third monitor 33 and the fourth monitor 34 are extended in the axial direction by the screwing action between the female screw and the male screw. As shown in FIG. 10, the arms 63 corresponding to the third monitor 33 and the fourth monitor 34 rotates upward in a standing direction with respect to the rotation brackets 61, and further, the respective monitor side connection portions 65 of the individual operation mechanisms 60 rotate in a direction to make the third monitor 33 and the fourth monitor 34 horizontal with respect to the arms 63.

The third monitor 33 and the fourth monitor 34 are disposed horizontally at positions higher than the first monitor 31 and the second monitor 32, and rear portions of the third monitor 33 and the fourth monitor 34 overlap the front portions of the first monitor 31 and the second monitor 32 in a plan view. That is, the table device 30 is a stepped table in which the monitor surfaces of the first and second monitors 31, 32 are the table surfaces, and the third and fourth monitors 33, 34 are shelves. Here, heights of the first to fourth monitors 31 to 34 can be adjusted by adjusting the tilt angles and lengths in the axial direction of the arms 63 of the first to fourth monitors 31 to 34.

<Stepped Table of Another Pattern>

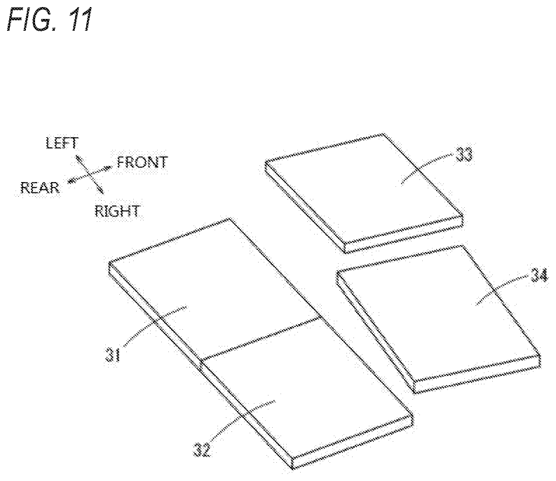

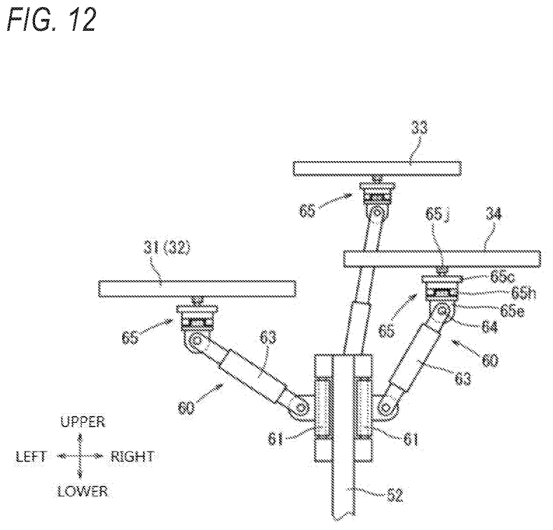

As shown in FIGS. 11 and 12, in a case where the table device 30 is used as a stepped table of another pattern, for example, the arms 63 of the individual operation mechanisms 60 operate as follows. That is, as shown in FIG. 12, from the state of the assembly table (see FIG. 8), the arms 63 corresponding to the third monitor 33 and the fourth monitor 34 rotate upward at different angles with respect to the rotation brackets 61 in the standing direction. Further, the monitor side connection portions 65 of the individual operation mechanisms 60 rotate in a direction which makes the third monitor 33 and the fourth monitor 34 horizontal with respect to the arms 63. As a result, the third monitor 33 and the fourth monitor 34 are disposed horizontally at positions higher than the first monitor 31 and the second monitor 32.

The arm 63 of the third monitor 33 is extended in the axial direction by the screwing action between the female screw and the male screw. As a result, the third monitor 33 is disposed horizontally at a position higher than the fourth monitor 34. That is, in the table device 30, the monitor surfaces of the first and second monitors 31, 32 can be used as the table surfaces, and the third and fourth monitors 33, 34 can be used as the shelves having different heights or the like. Here, the heights of the first to fourth monitors 31 to 34 can be adjusted by adjusting the tilt angles and the lengths in the axial direction of the arms 63 of the first to fourth monitors 31 to 34.

<Divided Table>

As shown in FIG. 13, in a case where the table device 30 is used as a divided table, for example, the arms 63 or the like of the individual operation mechanisms 60 operate as follows. That is, from the state of the assembly table (see FIG. 8), the arms 63 corresponding to the first to fourth monitors 31 to 34 rotate downward in the fall-down direction with respect to the rotation brackets 61. Further, the monitor side connection portions 65 of the individual operation mechanisms 60 rotate in a direction which makes the first to fourth monitors 31 to 34 horizontal with respect to the arms 63. As a result, the first to fourth monitors 31 to 34 are spaced from each other in a horizontal state.

As shown in FIG. 13, the rotation brackets 61 of the individual operation mechanisms 60 corresponding to the first to fourth monitors 31 to 34 horizontally rotates around the support shafts 61c of the columnar portion 52 of the link portion 50. As a result, horizontal positions of the first to fourth monitors 31 to 34 can be appropriately changed. Further, the first to fourth monitors 31 to 34 can rotate along the monitor surfaces by rotating the rotation shafts 65j of the monitor rotation portions 65c of the monitor side connection portions 65. Here, in order to make the divided table have a variation, the lengths of the arms 63 corresponding to the first to fourth monitors 31 to 34 can be appropriately adjusted.

<Folding of Table Device 30>

In a case where the table device 30 is folded, the arms 63 or the like of the individual operation mechanisms 60 operate as follows. That is, as shown in FIGS. 7 and 8, from the state of the assembly table, the arms 63 corresponding to the first to fourth monitors 31 to 34 rotate downward in the fall-down direction with respect to the rotation brackets 61, and the first to fourth monitors 31 to 34 are spaced from each other. Next, as shown in FIG. 4, the monitor side connection portions 65 corresponding to the first monitor 31 and the second monitor 32 rotate right with respect to the respective arms 63, and at the same time, the arms 63 stand up (left rotate) to an upright position with respect to the rotation brackets 61. As a result, the first monitor 31 and the second monitor 32 stand up so as to be parallel to the axes of the corresponding arms 63.

The monitor side connection portions 65 corresponding to the third monitor 33 and the fourth monitor 34 rotate left with respect to the respective arms 63, and at the same time, the arms 63 stand up (right rotate) to the upright position with respect to the rotation brackets 61. As a result, the third monitor 33 and the fourth monitor 34 stand up so as to be parallel to the axes of the corresponding arms 63. In this state, the first and second monitors 31, 32, and the third and fourth monitors 33, 34 stand up such that the back surfaces thereof face each other, and the table device 30 is folded.

<Correspondence Between Terms of Table Device 30 According to First Embodiment and Terms According to the Present Disclosure>

The first to fourth monitors 31 to 34 correspond to a flat plate portion of the present disclosure. For example, when the first monitor 31 corresponds to a first flat plate portion of the present disclosure, the second to fourth monitors 32 to 34 correspond to a second flat plate portion of the present disclosure. In addition, the monitor support mechanism 40 corresponds to a flat plate support mechanism of the present disclosure, and the individual operation mechanism 60 corresponds to a raising and lowering mechanism, a horizontal movement mechanism, and an angle adjustment mechanism of the present disclosure. The columnar portion 52 of the link portion 50 and the rotation bracket 61, or the columnar portion 52 of the link portion 50 correspond to a support portion of the flat plate support mechanism of the present disclosure.

<Advantages of Table Device 30 According to the Present Embodiment>

According to the table device 30 according to the present embodiment, the third monitor 33, the fourth monitor 34, or the like (second flat plate portion) are configured to be movable in a height direction in the horizontal state with respect to the first monitor 31 and the second monitor 32 (first flat plate portion) by an action of the individual operation mechanisms 60 (raising and lowering mechanism) in the monitor support mechanism 40 (flat plate support mechanism). Therefore, in a state in which the first monitor 31 and the second monitor 32 are used as a table, for example, the third monitor 33 and the fourth monitor 34 can be used as the shelves or the like. That is, since the height positions of the plurality of monitors 31 to 34 forming the table surface are changed individually, a usability of the table device 30 is improved. Further, the individual operation mechanisms 60 (raising and lowering mechanism) are configured to change the height positions of the corresponding first to fourth monitors 31 to 34 by changing the tilt angles of the arms 63. Therefore, a configuration of each of the individual operation mechanisms 60 becomes simple. In addition, the first to fourth monitors 31 to 34 can be horizontally moved by the arms 63. Since the arms 63 are configured to be extendable and contractable, it is easy to adjust the heights of the first to fourth monitors 31 to 34.

According to the table device 30 according to the present embodiment, the first monitor 31 (first flat plate portion) and the second to fourth monitors 32 to 34 (second flat plate portion) are configured to be relatively movable horizontally in any direction in the horizontal state by the action of the individual operation mechanisms 60 (horizontal movement mechanism). A shape of the table surface formed by the first to fourth monitors 31 to 34 can be changed to various shapes. Therefore, the usability of the table device 30 is improved. Further, the individual operation mechanisms 60 (horizontal movement mechanism) are configured to change the horizontal positions of the corresponding first to fourth monitors 31 to 34 by changing the tilt angles or the like of the arms 63. Therefore, a configuration of each of the individual operation mechanisms 60 becomes simple. In addition, the first to fourth monitors 31 to 34 can be moved in the height direction by the arms 63. Since the arms 63 are configured to be extendable and contractable, it is easy to adjust the horizontal positions of the first to fourth monitors 31 to 34.

According to the table device 30 according to the present embodiment, the first to fourth monitors 31 to 34 (the first flat plate portion and the second flat plate portion) are configured such that tilt angles are individually adjustable with respect to the horizontal plane by the action of the individual operation mechanisms 60 (angle adjustment mechanism) in the monitor support mechanism 40 (flat plate support mechanism). For example, it is possible to fold the first to fourth monitors 31 to 34 so as to overlap each other. In addition, in a state in which any one of the first to fourth monitors 31 to 34 is horizontally held, it is also possible to tilt and use the others. Therefore, the usability of the table device 30 is improved.

### Modified Example

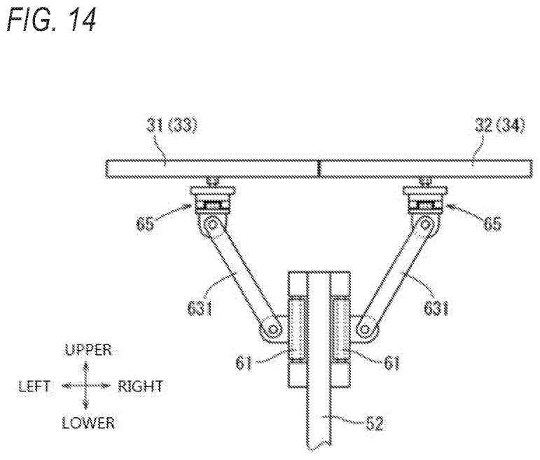

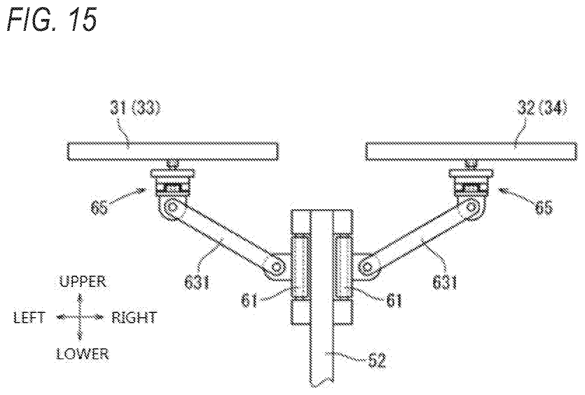

Here, the present disclosure is not limited to the above embodiment, and can be modified without departing from the scope of the present disclosure. For example, in the present embodiment, as shown in FIGS. 4 to 10 or the like, an example is shown in which the arms 63 whose lengths can be adjusted in the axial direction in the individual operation mechanisms 60 are used. However, as shown in FIGS. 14 and 15, an arm 631 having a fixed length can be used.

### Second Embodiment

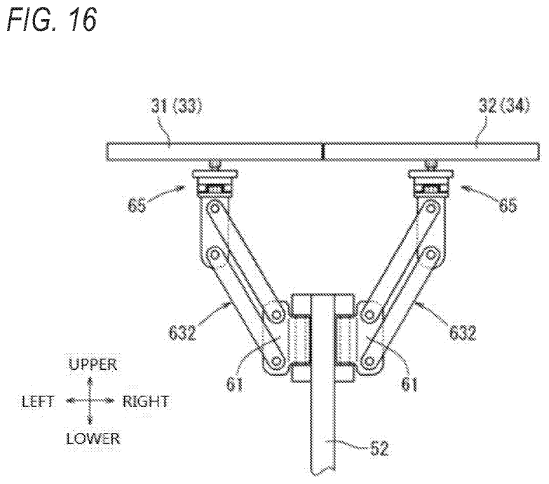

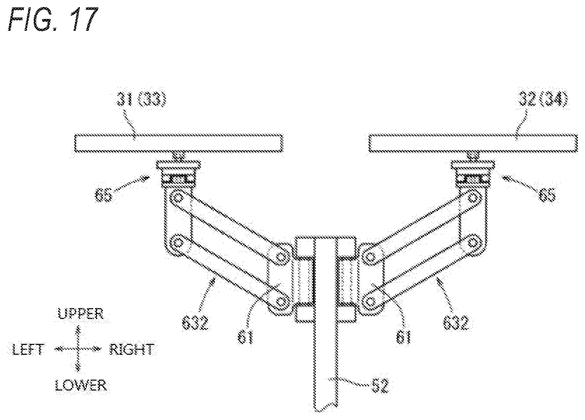

Next, the table device 30 of the vehicle according to a second embodiment of the present disclosure will be described with reference to FIGS. 16 and 17. The table device 30 of the vehicle according to the second embodiment uses a four-joint link mechanism 632, instead of the arms 63, 631 used in the table device 30 according to the first embodiment. As a result, the first to fourth monitors 31 to 34 are raised and lowered in the horizontal state. Therefore, unlike the table device 30 according to the first embodiment, when the first to fourth monitors 31 to 34 are raised and lowered by tilting the arms 63, a control for horizontally holding the first to fourth monitors 31 to 34 by vertically rotating the monitor side connection portions 65 with respect to the arms 63 is not necessary.

### Third Embodiment

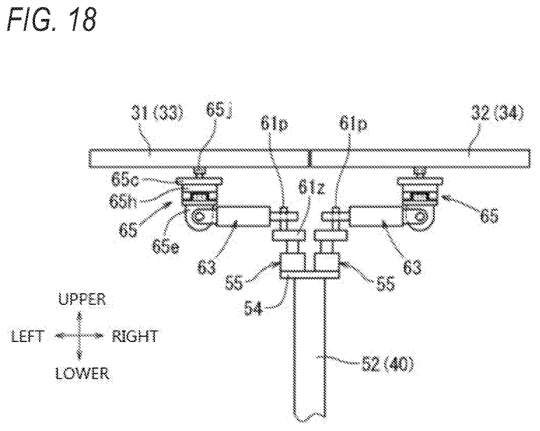

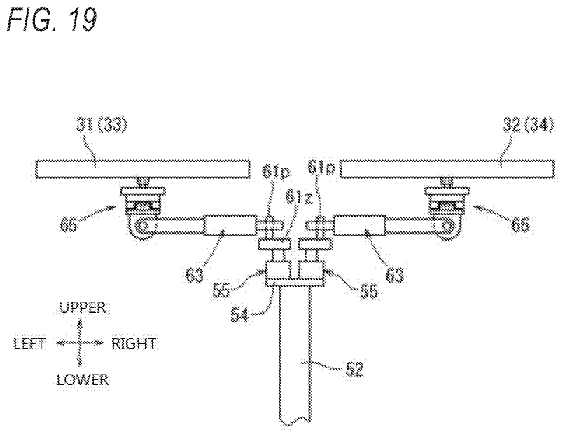

Next, the table device 30 of the vehicle according to a third embodiment of the present disclosure will be described with reference to FIGS. 18 and 19. In the table device 30 according to the present embodiment, a mechanism configured to raise and lower the first to fourth monitors 31 to 34 and a mechanism configured to horizontally move the first to fourth monitors 31 to 34 are separately provided. That is, in the table device 30 according to the present embodiment, a horizontal support base 54 is provided on an upper surface of the columnar portion 52 of the monitor support mechanism 40 (link portion 50), and a plurality of arm-like (four) raising and lowering mechanisms 55 capable of adjusting lengths in the axial direction are installed in a vertical direction on the horizontal support base 54. Each of a raising and lowering base portions 61z is supported by the raising and lowering mechanisms 55 so as to enable to be raised and lowered in a horizontal state. On the raising and lowering base portions 61z, rotation center pins 61p are erected so as to correspond to the first to fourth monitors 31 to 34, respectively. The base end portions of the arms 63 are connected to the respective rotation center pins 61p in a horizontally rotatable manner. In addition, the base portions 65e of the monitor side connection portions 65 are connected to the tip ends of the arms 63 in the vertically rotatable manner, respectively. The rotation shafts 65j of the monitor rotation portions 65c of the monitor side connection portions 65 are connected to the centers of the back surfaces of the corresponding first to fourth monitors 31 to 34.

According to the above configuration, the raising and lowering base portions 61z are raised and lowered by the raising and lowering mechanisms 55, so that the first to fourth monitors 31 to 34 can be raised and lowered. As shown in FIG. 18, in a state in which the table device 30 is the assembly table, the first to fourth monitors 31 to 34 can be spaced in the horizontal state by extending the arms 63 by using the screwing action between the male screw and the female screw. In addition, the lengths of the corresponding arms 63 of the first to fourth monitors 31 to 34 are adjusted, and further, the arms 63 are rotated around the rotation center pins 61p on the raising and lowering base portions 61z, so that the first to fourth monitors 31 to 34 can be disposed at desired positions.

When the first to fourth monitors 31 to 34 are in the state of the assembly table (see FIG. 18), for example, the base portions 65e of the monitor side connection portions 65 can be rotated with respect to the arms 63 to fold the table device 30. That is, by rotating the base portions 65e of the monitor side connection portions 65 corresponding to the first and third monitors 31, 33 to the left with respect to the arms 63, the first and third monitors 31, 33 can be made to stand up. Similarly, by rotating the base portions 65e of the monitor side connection portions 65 corresponding to the second and fourth monitor 32, 34 to the right with respect to the arms 63, the second and fourth monitors 32, 34 can be made to stand up.

As a result, the back surfaces of the first and third monitors 31, 33, and the second and fourth monitors 32, 34 face each other, and the table device 30 is folded. By rotating the hinge portions 65h of the monitor side connection portions 65 corresponding to the first to fourth monitors 31 to 34 around the hinge axes, the first to fourth monitors 31 to 34 can be stood up along the axes of the arms 63, so that the table device 30 can also be folded.

### Fourth Embodiment

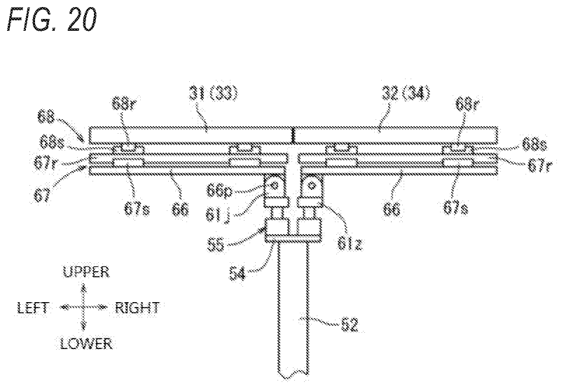

Next, the table device 30 of the vehicle according to a fourth embodiment of the present disclosure will be described with reference to FIGS. 20 to 23. The table device 30 according to the present embodiment uses a left-right slide mechanism 67, a front-rear slide mechanism 68 or the like, instead of the arms 63 used for the horizontal movements of the first to fourth monitors 31 to 34 in the table device 30 according to the third embodiment (see FIG. 18). That is, the horizontal support base 54 is provided on the upper surface of the columnar portion 52 of the monitor support mechanism 40, and the plurality of (four) raising and lowering mechanisms 55 are installed in the vertical direction on the horizontal support base 54. Each of the raising and lowering base portions 61z is supported by the raising and lowering mechanisms 55 so as to enable to be raised and lowered in a horizontal state. Horizontal bearing portions 61j of the individual operation mechanisms 60 are provided corresponding to the first to fourth monitors 31 to 34 on the respective raising and lowering base portions 61z.

The individual operation mechanisms 60 include rotation support base portions 66 corresponding to the first to fourth monitors 31 to 34. Each of the rotation support base portions 66 is formed in a table shape, and a bracket (not shown) including a rotation center shaft 66p is provided at a back side end edge of the rotation support base portion 66. Further, the rotation center shaft 66p of each of the rotation support base portions 66 is supported rotatably with respect to the horizontal bearing portion 61j of the corresponding raising and lowering base portion 61z. As a result, each of the rotation support base portions 66 corresponding to the first to fourth monitors 31 to 34 can rotate vertically around the horizontal bearing portion 61j of the raising and lowering base portion 61z.

As shown in FIG. 20 or the like, a plurality of sliders 67s of the left-right slide mechanism 67 are fixed on the rotation support base portion 66, and a pair of rails 67r of the left-right slide mechanism 67 are fitted to the sliders 67s in a left-right slidable manner. In addition, a plurality of sliders 68s of the front-rear slide mechanism 68 are fixed at predetermined positions on the pair of rails 67r of the left-right slide mechanism 67, and a pair of rails 68r of the front-rear slide mechanism 68 are fitted to the sliders 68s in a front-rear slidable manner. The pair of rails 68r of the front-rear slide mechanism 68 are fixed to the back surface of each of the corresponding first to fourth monitors 31 to 34.

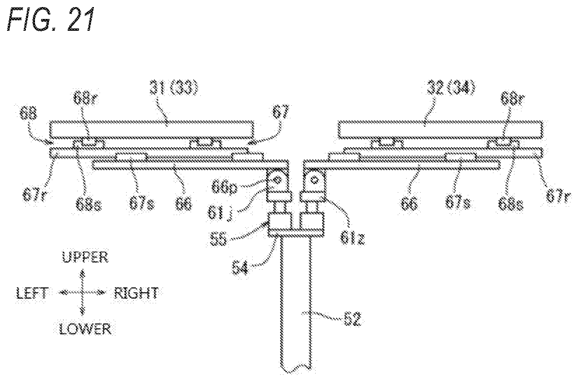

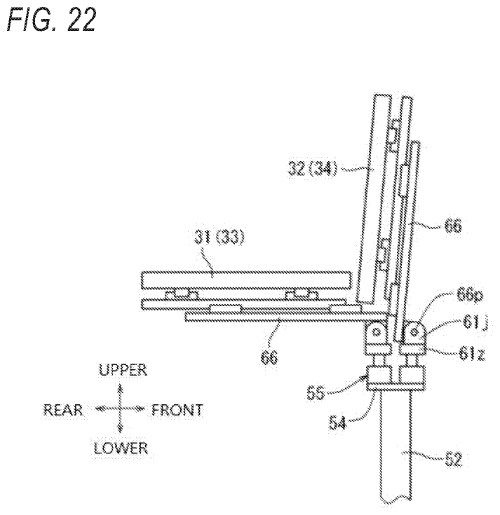

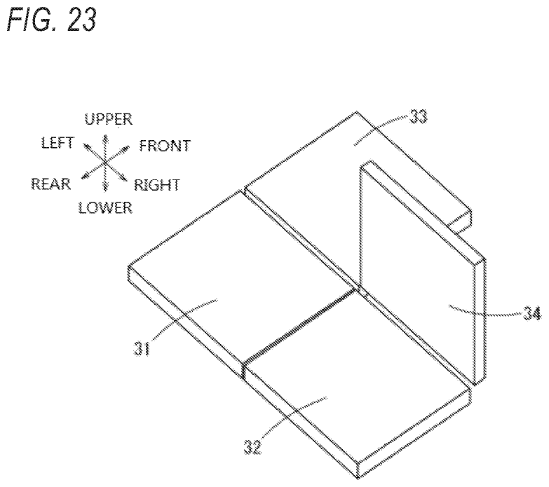

According to the above configuration, the raising and lowering base portions 61z are raised and lowered by the raising and lowering mechanisms 55, so that the first to fourth monitors 31 to 34 can be raised and lowered. As shown in FIG. 20, when the first to fourth monitors 31 to 34 are in the state of the assembly table, for example, as shown in FIG. 21, by operating the left-right slide mechanisms 67 and the front-rear slide mechanisms 68, the first to fourth monitors 31 to 34 can be spaced from each other. In addition, when the first to fourth monitors 31 to 34 are in the state of the assembly table (see FIG. 20), the rotation support base portion 66 corresponding to any of the monitors 31 to 34 can be rotated vertically. As a result, for example, as shown in FIGS. 22 and 23, by rotating (left rotating) the rotation support base portion 66 corresponding to the fourth monitor 34 upward around the rotation center shaft 66p, the first to third monitors 31 to 33 can be used as a table, and the fourth monitor 34 can be used for a display or the like.

Further, by rotating (left rotating) the rotation support base portions 66 corresponding to the first and third monitors 31, 33 downward around the rotation center shafts 66p, and rotating (right rotating) the rotation support base portions 66 corresponding to the second and fourth monitors 32, 34 downward around the rotation center shafts 66p, from the state shown in FIG. 20, the table device 30 can be folded.

### Fifth Embodiment

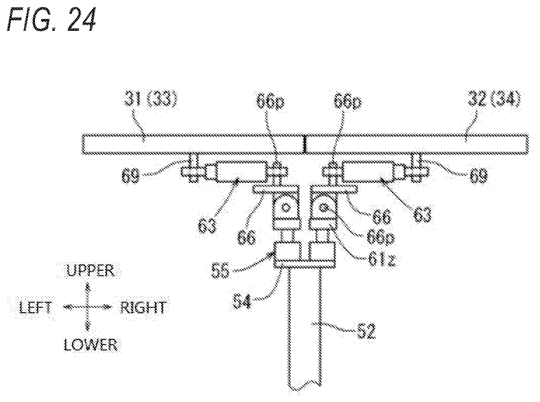

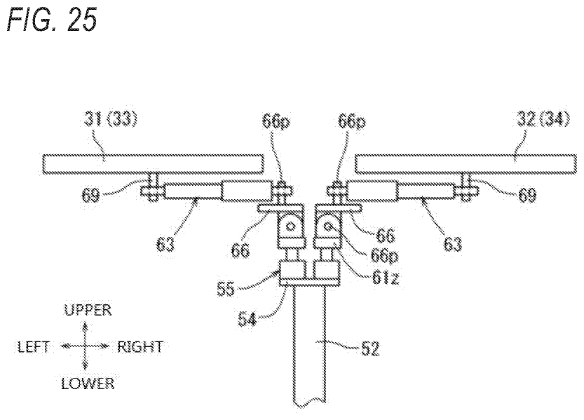

Next, the table device 30 of the vehicle according to a fifth embodiment of the present disclosure will be described with reference to FIGS. 24 and 25. The table device 30 according to the present embodiment uses the arms 63 instead of the left-right slide mechanisms 67 and the front-rear slide mechanisms 68 in the table device 30 (see FIG. 20 or the like) according to the fourth embodiment. That is, as shown in FIG. 24 or the like, the rotation center pin 66p is erected on each of the rotation support base portions 66 corresponding to the first to fourth monitors 31 to 34, and the base end portion of each of the arms 63 is connected to the rotation center pin 66p in the horizontally rotatable manner. The tip end of the arm 63 is connected to a connecting vertical pin 69 at a center of each of the back surfaces of the corresponding first to fourth monitors 31 to 34 in the horizontally rotatable manner.

According to the above configuration, as shown in FIG. 24, the first to fourth monitors 31 to 34 can be spaced from each other by extending the respective arms 63 when the first to fourth monitors 31 to 34 are in the state of the assembly table. In addition, by rotating (left rotating) the rotation support base portions 66 corresponding to the first and third monitor 31, 33 downward, and rotating (right rotating) the rotation support base portions 66 corresponding to the second and fourth monitors 32, 34, from the state of the assembly table, the table device 30 can be folded.

### Sixth Embodiment

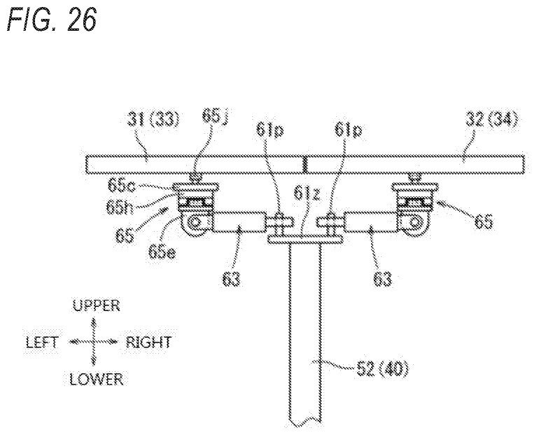

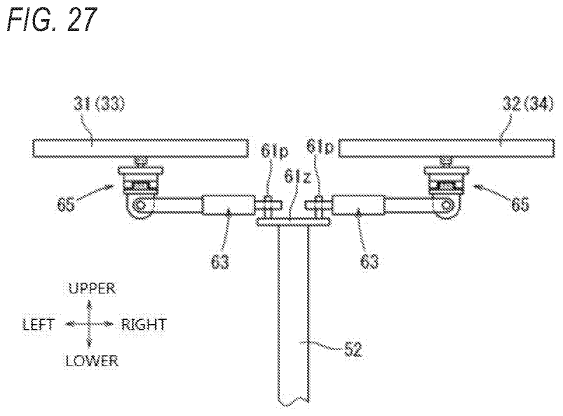

Next, the table device 30 of the vehicle according to a sixth embodiment of the present disclosure will be described with reference to FIGS. 26 and 27. In the table device 30 according to the present embodiment, the arms 63 mainly used for raising and lowering the first to fourth monitors 31 to 34 in the table device 30 according to the first embodiment are used for the horizontal movements of the first to fourth monitors 31 to 34. That is, a fixed support base portion 61z is horizontally fixed to an upper end of the columnar portion 52 of the monitor support mechanism 40, and four rotation center pins 61p are erected on the fixed support base portion 61z at equal intervals in a circumferential direction corresponding to the first to fourth monitors 31 to 34, respectively. The base end portions of the arms 63 of the individual operation mechanisms 60 are connected to the respective rotation center pins 61p in the horizontally rotatable manner. In addition, the base portions 65e of the monitor side connection portions 65 are connected to the tip ends of the arms 63 in the vertically rotatable manner, respectively. The rotation shafts 65j of the monitor rotation portions 65c of the monitor side connection portions 65 are connected to the centers of the back surfaces of the corresponding first to fourth monitors 31 to 34.

According to the above configuration, as shown in FIG. 26, in the state in which the table device 30 is the assembly table, the first to fourth monitors 31 to 34 can be spaced in the horizontal state by extending the arms 63 by using the screwing action between the male screw and the female screw. In addition, the lengths of the arms 63 corresponding to the first to fourth monitors 31 to 34 are adjusted, and further, the arms 63 are rotated around the rotation center pins 61p on the fixed support base portions 61z, so that the first to fourth monitors 31 to 34 can be disposed at desired positions.

When the first to fourth monitors 31 to 34 are in the state of the assembly table (see FIG. 26), for example, the base portions 65e of the monitor side connection portions 65 can be rotated with respect to the arms 63 to fold the table device 30. That is, by rotating the base portions 65e of the monitor side connection portions 65 corresponding to the first and third monitors 31, 33 to the left with respect to the arms 63, the first and third monitors 31, 33 can be made to stand up. Similarly, by rotating the base portions 65e of the monitor side connection portions 65 corresponding to the second and fourth monitor 32, 34 to the right with respect to the arms 63, the second and fourth monitors 32, 34 can be made to stand up.

As a result, the back surfaces of the first and third monitors 31, 33, and the second and fourth monitors 32, 34 face each other, and the table device 30 is folded. By rotating the hinge portions 65h of the monitor side connection portions 65 corresponding to the first to fourth monitors 31 to 34 around the hinge axes, the first to fourth monitors 31 to 34 can be stood up along the axes of the arms 63, so that the table device 30 can also be folded.

### Seventh Embodiment

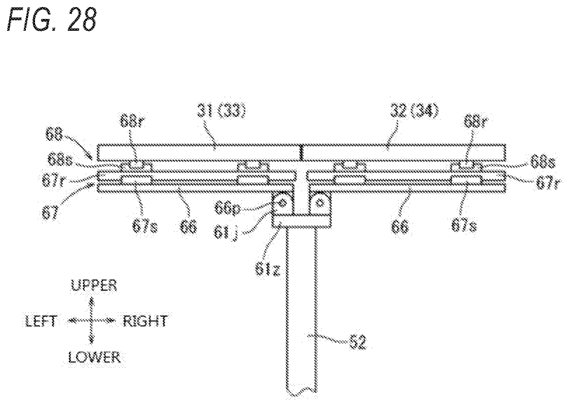

Next, the table device 30 of the vehicle according to a seventh embodiment of the present disclosure will be described with reference to FIGS. 28 to 31. The table device 30 according to the present embodiment uses the left-right slide mechanisms 67, the front-rear slide mechanisms 68 or the like, instead of the arms 63 used for the horizontal movements of the first to fourth monitors 31 to 34 in the table device 30 according to the sixth embodiment (see FIG. 26). That is, the fixed support base portion 61z is horizontally fixed to the upper end of the columnar portion 52 of the monitor support mechanism 40, and four sets of horizontal bearing portions 61j of the individual operation mechanisms 60 are provided on the fixed support base portion 61z corresponding to the first to fourth monitors 31 to 34, respectively.

The individual operation mechanisms 60 include the rotation support base portions 66 corresponding to the first to fourth monitors 31 to 34. Each of the rotation support base portions 66 is formed in a table shape, and the bracket (not shown) including the rotation center shaft 66p is provided at the back side end edge of the rotation support base portion 66. Further, the rotation center shaft 66p of each of the rotation support base portions 66 is supported rotatably with respect to the horizontal bearing portion 61j of the corresponding fixed support base portion 61z. As a result, each of the rotation support base portions 66 corresponding to the first to fourth monitors 31 to 34 can rotate vertically around the horizontal bearing portion 61j of the fixed support base portion 61z.

As shown in FIG. 28 or the like, the plurality of sliders 67s of the left-right slide mechanism 67 are fixed on the rotation support base portion 66, and the pair of rails 67r of the left-right slide mechanism 67 are fitted to the sliders 67s in the left-right slidable manner. In addition, the plurality of sliders 68s of the front-rear slide mechanism 68 are fixed at the predetermined positions on the pair of rails 67r of the left-right slide mechanism 67, and the pair of rails 68r of the front-rear slide mechanism 68 are fitted to the sliders 68s in the front-rear slidable manner. The pair of rails 68r of the front-rear slide mechanism 68 are fixed to the back surface of each of the corresponding first to fourth monitors 31 to 34. That is, the rotation support base portion 66 corresponds to a support base portion of the present disclosure, and the left-right slide mechanism 67 and the front-rear slide mechanism 68 correspond to a multi-directional slide mechanism in the horizontal movement mechanism of the present disclosure.

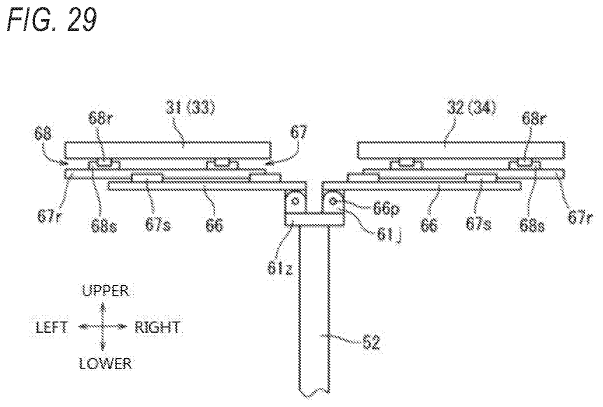

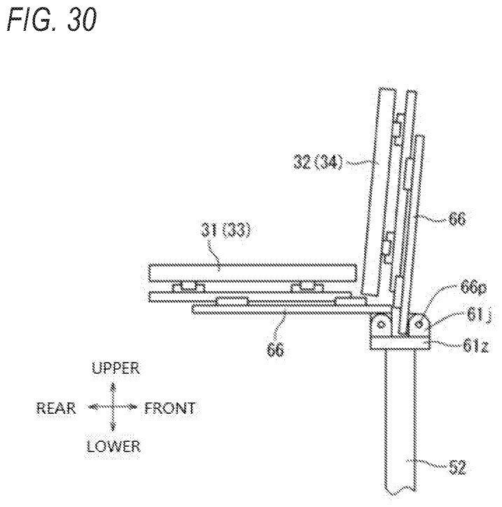

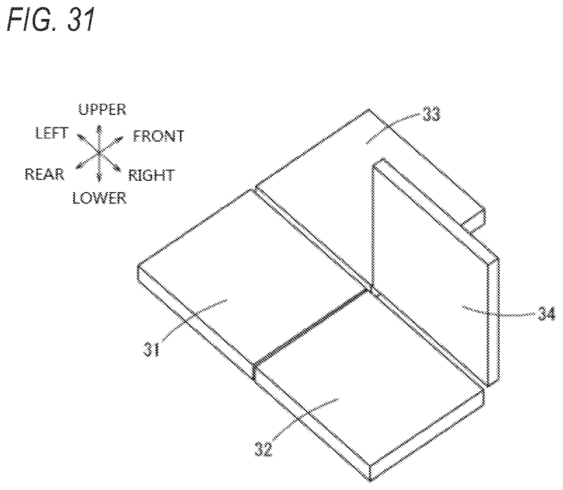

According to the above configuration, as shown in FIG. 28, when the first to fourth monitors 31 to 34 are in the state of the assembly table, for example, as shown in FIG. 29, by operating the left-right slide mechanisms 67 and the front-rear slide mechanisms 68, the first to fourth monitors 31 to 34 can be spaced from each other. In addition, when the first to fourth monitors 31 to 34 are in the state of the assembly table (see FIG. 28), the rotation support base portion 66 corresponding to any of the monitors 31 to 34 can be rotated vertically. As a result, for example, as shown in FIGS. 30 and 31, by rotating (left rotating) the rotation support base portion 66 corresponding to the fourth monitor 34 upward around the rotation center shaft 66p, the first to third monitors 31 to 33 can be used as the table, and the fourth monitor 34 can be used for the display or the like.

By rotating (left rotating) the rotation support base portions 66 corresponding to the first and third monitors 31, 33 downward around the rotation center shafts 66p, and rotating (right rotating) the rotation support base portions 66 corresponding to the second and fourth monitors 32, 34 downward around the rotation center shafts 66p, from the state shown in FIG. 28, the table device 30 can be folded.

### Eighth Embodiment

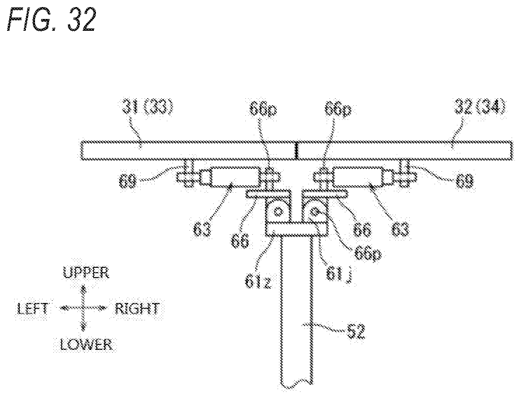

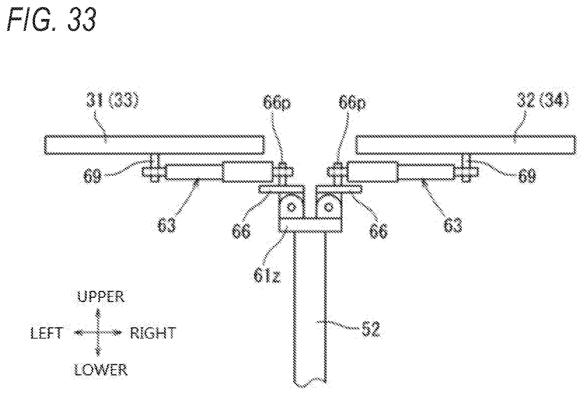

Next, the table device 30 of the vehicle according to an eighth embodiment of the present disclosure will be described with reference to FIGS. 32 and 33. The table device 30 according to the present embodiment uses the arms 63 instead of the left-right slide mechanisms 67 and the front-rear slide mechanisms 68 in the table device 30 (see FIG. 28 or the like) according to the seventh embodiment. That is, as shown in FIG. 32 or the like, the rotation center pin 66p is erected on each of the rotation support base portions 66 corresponding to the first to fourth monitors 31 to 34, and the base end portion of each of the arms 63 is connected to the rotation center pin 66p in the horizontally rotatable manner. The tip end of the arm 63 is connected to the connecting vertical pin 69 at the center of each of the back surfaces of the corresponding first to fourth monitors 31 to 34 in the horizontally rotatable manner.

According to the above configuration, as shown in FIG. 32, the first to fourth monitors 31 to 34 can be spaced from each other by extending the respective arms 63 when the first to fourth monitors 31 to 34 are in the state of the assembly table. In addition, by rotating (left rotating) the rotation support base portions 66 corresponding to the first and third monitor 31, 33 downward, and rotating (right rotating) the rotation support base portions 66 corresponding to the second and fourth monitors 32, 34, from the state of the assembly table, the table device 30 can be folded.

### Modified Example

Here, in the first to eighth embodiments, as described above, the table device 30 including the four monitors 31 to 34 is exemplified. However, for example, it is also possible to expand the three monitors radially to form a table, or it is also possible to form the table using four or more monitors. Although the table device 30 including the first to fourth monitors 31 to 34 is exemplified, it is also possible to use a wood plate or a resin plate instead of the first to fourth monitors 31 to 34. In the first to eighth embodiments, the first to fourth monitors 31 to 34 are raised and lowered, or horizontally moved by operating the monitor support mechanism 40 (flat plate support mechanism) and the individual operation mechanisms 60 (raising and lowering mechanism or horizontal movement mechanism) by a driving force such as a motor. However, the first to fourth monitors 31 to 34 may also be raised and lowered, or moved horizontally by operating the monitor support mechanism 40 (flat plate support mechanism) and the individual operation mechanisms 60 (raising and lowering mechanism or horizontal movement mechanism) by manually applying an external force. In addition, in the first to eighth embodiments, the first to fourth monitors 31 to 34 are folded by operating the monitor support mechanism 40 (flat plate support mechanism) and the individual operation mechanisms 60 (angle adjustment mechanism) by a driving force such as a motor. However, the first monitor 31 to the fourth monitor 34 may also be folded by operating the monitor support mechanism 40 (flat plate support mechanism) and the individual operation mechanisms 60 (angle adjustment mechanism) by manually applying an external force. Although the table device 30 used in the autonomously drivable vehicle 10 is exemplified in the present embodiment, the table device 30 may also be used in a vehicle such as a train, a ship, and a passenger aircraft. In addition, it is also possible to use the table device 30 like an ordinary furniture.

The present disclosure provides illustrative, non-limiting examples as follows:

According to a first aspect of the present disclosure, there is provided a table device including: a plurality of flat plate portions configured to form a table surface and including a first flat plate portion and a second flat plate portion; and a flat plate support mechanism supporting the first flat plate portion and the second flat plate portion in a horizontal state so that the first flat plate portion and the second flat plate portion are capable of forming a continuous table surface, wherein the flat plate support mechanism includes a raising and lowering mechanism configured to support the first flat plate portion and the second flat plate portion so that the first flat plate portion and the second flat plate portion in the horizontal state are movable relative to each other in a height direction.

Accordingly, the first flat plate portion and the second flat plate portion are movable in the height direction in the horizontal state by an action of the raising and lowering mechanism of the flat plate support mechanism. Therefore, for example, in a state in which the first flat plate portion is used as a table, the second flat plate portion can be used as a shelf or the like. That is, since the height positions of the plurality of flat plate portions forming the table surface can be changed individually, the usability of the table device is improved.

According to a second aspect of the present disclosure, there is provided the table device according to the first aspect, wherein the raising and lowering mechanism includes a plurality of arms respectively corresponding to the plurality of flat plate portions, and wherein base end portions of the plurality of arms are connected to a support portion of the flat plate support mechanism in a vertically rotatable manner, and tip ends of the plurality of arms are connected to back surfaces of the corresponding flat plate portions in a vertically rotatable manner. Therefore, the height positions of the corresponding flat plate portions can be changed by changing tilt angles of the arms. Accordingly, the configuration of the raising and lowering mechanism becomes simple. In addition, it is also possible to horizontally move the flat plate portions by the arms.

According to a third aspect of the present disclosure, there is provided the table device according to the second aspect, wherein the plurality of arms are configured to be extendable and contractable. Therefore, the height positions of the corresponding flat plate portions can be changed by adjusting lengths of the arms, and the height positions of the flat plate portions can be adjusted within a wide range.

According to a fourth aspect of the present disclosure, there is provided the table device according to the first aspect, wherein the raising and lowering mechanism includes a plurality of sets of four-joint link mechanisms respectively corresponding to the plurality of flat plate portions, and wherein one ends of the plurality of sets of four-joint link mechanisms are connected to a support portion of the flat plate support mechanism in a vertically rotatable manner, and another ends of the plurality of sets of four-joint link mechanisms are connected to back surfaces of the corresponding flat plate portion in a vertically rotatable manner. Therefore, it is possible to raise and lower the flat plate portions while being held horizontally.

According to a fifth aspect of the present disclosure, there is provided the table device according to any one of the first to fourth aspects, further including: a third flat plate portion, wherein the raising and lowering mechanism is configured to hold the second flat plate portion and the third flat plate portion at different height positions with respect to a height position of the first flat plate portion. Therefore, the usability of the table device is further improved.

According to a sixth aspect of the present disclosure, there is provided the table device according to any one of the first to fifth aspects, wherein the raising and lowering mechanism is configured to change height positions of the plurality of flat plate portions in a state in which a part of the plurality of flat plate portions overlap with each other in a plan view.

According to a seventh aspect of the present disclosure, there is provided the table device according to any one of the first to fifth aspects, wherein the raising and lowering mechanism is configured to change a height position of the plurality of flat plate portions in a state in which the plurality of flat plate portions are spaced from each other in a horizontal direction.

According to an eighth aspect of the present disclosure, there is provided the table device according to any one of the first to seventh aspects, wherein the raising and lowering mechanism includes a driving source configured to relatively move the first flat plate portion and the second flat plate portion in the height direction. Therefore, the first flat plate portion and the second flat plate portion can be automatically moved relative to each other in the height direction.

According to a ninth aspect of the present disclosure, there is provided the table device according to any one of the first to seventh aspects, wherein the raising and lowering mechanism is configured to relatively move the first flat plate portion and the second flat plate portion in the height direction by applying an external force to the first flat plate portion and the second flat plate portion. That is, the first flat plate portion and the second flat plate portion can be manually moved relative to each other in the height direction.

According to a tenth aspect of the present disclosure, there is provided a table device including: a plurality of flat plate portions configured to form a table surface and including a first flat plate portion and a second flat plate portion; and a flat plate support mechanism supporting the first flat plate portion and the second flat plate portion in a horizontal state so that the first flat plate portion and the second flat plate portion are capable of forming a continuous table surface, wherein the flat plate support mechanism includes a horizontal movement mechanism configured to support the first flat plate portion so that the first plate portion is horizontally movable with respect to the second flat plate portion in any direction in the horizontal state.

Accordingly, the first flat plate portion is horizontally movable with respect to the second flat plate portion in any direction in the horizontal state by an action of the horizontal movement mechanism of the flat plate support mechanism. Therefore, a shape of the table surface formed by the first flat plate portion and the second flat plate portion can be changed to various shapes. Therefore, the usability of the table device is improved.

According to an eleventh aspect of the present disclosure, there is provided the table device according to the tenth aspect, wherein the horizontal movement mechanism includes a plurality of multi-directional slide mechanisms respectively corresponding to the plurality of flat plate portions, and wherein the plurality of multi-directional slide mechanisms are mounted on a support base portion of the flat plate support mechanism, and the flat plate portions corresponding to the multi-directional slide mechanisms are mounted on the respective multi-directional slide mechanisms. In this way, by using the multi-directional slide mechanisms, the flat plate portions can be moved in any direction while being held horizontally.

According to a twelfth aspect of the present disclosure, there is provided the table device according to the tenth aspect, wherein the horizontal movement mechanism includes a plurality of rotation brackets connected to a support portion of the flat plate support mechanism in a horizontally rotatable manner, and a plurality of arms whose base end portions are respectively connected to the plurality of rotation brackets in a vertically rotatable manner, and wherein tip ends of the plurality of arms are connected to back surfaces of the corresponding plurality of flat plate portions in a vertically rotatable manner. Therefore, by adjusting horizontal rotation angles of the rotation brackets and the tilt angles of the arms, horizontal positions of the corresponding flat plate portions can be arbitrarily changed. That is, a mechanism for moving the flat plate portions in the horizontal direction can be simplified.

According to a thirteenth aspect of the present disclosure, there is provided the table device according to the tenth aspect, wherein the horizontal movement mechanism includes a plurality of extendable and contractable arms corresponding to the plurality of flat plate portions, and wherein, in a state in which the plurality of arms are held horizontally, base end portions of the plurality of arms are connected to a support base portion of the flat plate support mechanism in a horizontally rotatable manner, and tip ends of the plurality of arms are connected to back surfaces of the corresponding flat plate portion in a horizontally rotatable manner. Therefore, horizontal positions of the corresponding flat plate portions can be arbitrarily changed by the horizontal rotation angles of the arms and the extension and contraction of the arms.

According to a fourteenth aspect of the present disclosure, there is provided the table device according to any one of the tenth to thirteenth aspects, therein a planar shape of the table surface formed by the plurality of flat plate portions can be changed into an arbitrary shape.

According to a fifteenth aspect of the present disclosure, there is provided the table device according to any one of the tenth to fourteenth aspects, wherein the horizontal movement mechanism includes a driving source configured to horizontally move the first flat plate portion with respect to the second flat plate portion. Therefore, the first flat plate portion can be automatically moved horizontally with respect to the second flat plate portion.

According to a sixteenth aspect of the present disclosure, there is provided the table device according to any one of the tenth to fourteenth aspects, wherein the horizontal movement mechanism is configured to relatively horizontally move the first flat plate portion and the second flat plate portion by applying an external force to the first flat plate portion and the second flat plate portion. That is, the first flat plate portion and the second flat plate portion can be manually moved relatively horizontally.

According to a seventeenth aspect of the present disclosure, there is provided a table device including: a plurality of flat plate portions configured to form a table surface and including a first flat plate portion and a second flat plate portion; and a flat plate support mechanism configured to support the first flat plate portion and the second flat plate portion in a horizontal state so that the first flat plate portion and the second flat plate portion are capable of forming a continuous table surface, wherein the flat plate support mechanism includes an angle adjustment mechanism configured to support the first flat plate portion and the second flat plate portion so that tilt angles of the first flat plate portion and the second flat plate portion with respect to a horizontal plane are capable of being individually adjusted.

Accordingly, the first flat plate portion and the second flat plate portion are capable of individually adjusting the tilt angles thereof with respect to the horizontal plane by an action of the angle adjustment mechanism of the flat plate support mechanism. Therefore, for example, the first flat plate portion and the second flat plate portion can be folded so as to overlap each other. In addition, in a state in which one of the first flat plate portion and the second flat plate portion is held horizontally, it is also possible to use the other one by tilting the same. Therefore, the usability of the table device is improved.

According to an eighteenth aspect of the present disclosure, there is provided the table device according to the seventeenth aspect, wherein the angle adjustment mechanism includes a plurality of arms respectively corresponding to the plurality of flat plate portions, and wherein base end portions of the plurality of arms are connected to a support portion of the flat plate support mechanism in a vertically rotatable manner, and tip ends of the plurality of arms are connected to back surfaces of the corresponding flat plate portions in a vertically rotatable manner. Therefore, by adjusting the tilt angles of the arms or the tilt angles of the flat plate portions with respect to the arms, the tilt angles of the flat plate portions with respect to the horizontal plane can be changed.

According to a nineteenth aspect of the present disclosure, there is provided the table device according to the seventeenth aspect, wherein the flat plate support mechanism includes a plurality of support base portions respectively corresponding to the plurality of flat plate portions, and a slide mechanism provided on each of the support base portions and configured to slidably support each of the flat plate portions along each of the support base portions, and wherein the angle adjustment mechanism is configured to adjust tilt angles of the support base portions. That is, the angle adjustment mechanism can change the tilt angles of the flat plate portions with respect to the horizontal plane by adjusting the tilt angle of the support base portion.

According to a twentieth aspect of the present disclosure, there is provided the table device according to any one of the seventeenth to nineteenth aspect, wherein the angle adjustment mechanism is configured to relatively adjust the tilt angles of the first flat plate portion and the second flat plate portion so that the first flat plate portion and the second flat plate portion overlap with each other, thereby folding the table surface.

According to a twenty-first aspect of the present disclosure, there is provided the table device according to any one of claims the seventeenth to twentieth aspect, wherein at least one of the flat plate portions functions as a monitor, and wherein the angle adjustment mechanism is configured to tilt one of the first flat plate portion and the second flat plate portion with respect to the horizontal plane so as to be usable as a monitor while holding another of the first flat plate portion and the second flat plate portion in the horizontal state. Therefore, the usability of the table device is further improved.

According to a twenty-second aspect of the present disclosure, there is provided the table device according to any one of the seventeenth to twenty-first aspects, wherein the angle adjustment mechanism includes a driving source configured to adjust the tilt angles of the first flat plate portion and the second flat plate portion with respect to the horizontal plane. Therefore, the tilt angles of the first flat plate portion and the second flat plate portion with respect to the horizontal plane can be adjusted automatically.

According to a twenty-third aspect of the present disclosure, there is provided the table device according to any one of the seventeenth to twenty-first aspects, wherein the angle adjustment mechanism is configured to adjust the tilt angles of the first flat plate portion and the second flat plate portion with respect to the horizontal plane by an external force applied to the first flat plate portion and the second flat plate portion. That is, the tilt angles of the first flat plate portion and the second flat plate portion with respect to the horizontal plane can be adjusted manually.

What is claimed is:

1. A table device comprising:
a plurality of flat plate portions configured to form a table surface and including a first flat plate portion and a second flat plate portion; and
a flat plate support mechanism supporting the first flat plate portion and the second flat plate portion in a horizontal state so that the first flat plate portion and the second flat plate portion are capable of forming a continuous table surface,
wherein the flat plate support mechanism includes a raising and lowering mechanism configured to support the first flat plate portion and the second flat plate portion so that the first flat plate portion and the second flat plate portion in the horizontal state are movable relative to each other in a height direction.

2. The table device according to claim 1,
wherein the raising and lowering mechanism includes a plurality of arms respectively corresponding to the plurality of flat plate portions, and
wherein base end portions of the plurality of arms are connected to a support portion of the flat plate support mechanism in a vertically rotatable manner, and tip ends of the plurality of arms are connected to back surfaces of the corresponding flat plate portions in a vertically rotatable manner.

3. The table device according to claim 2,
wherein the plurality of arms are configured to be extendable and contractable.

4. The table device according to claim 1,
wherein the raising and lowering mechanism includes a plurality of sets of four-joint link mechanisms respectively corresponding to the plurality of flat plate portions, and
wherein one ends of the plurality of sets of four-joint link mechanisms are connected to a support portion of the flat plate support mechanism in a vertically rotatable manner, and another ends of the plurality of sets of four-joint link mechanisms are connected to back surfaces of the corresponding flat plate portion in a vertically rotatable manner.

5. The table device according to claim 1, further comprising:
a third flat plate portion,
wherein the raising and lowering mechanism is configured to hold the second flat plate portion and the third flat plate portion at different height positions with respect to a height position of the first flat plate portion.

6. The table device according to claim 1,
wherein the raising and lowering mechanism is configured to change height positions of the plurality of flat plate portions in a state in which a part of the plurality of flat plate portions overlap with each other in a plan view.

7. The table device according to claim 1,
wherein the raising and lowering mechanism is configured to change a height position of the plurality of flat plate portions in a state in which the plurality of flat plate portions are spaced from each other in a horizontal direction.

8. The table device according to claim 1,
wherein the raising and lowering mechanism includes a driving source configured to relatively move the first flat plate portion and the second flat plate portion in the height direction.

9. The table device according to claim 1,
wherein the raising and lowering mechanism is configured to relatively move the first flat plate portion and the second flat plate portion in the height direction by applying an external force to the first flat plate portion and the second flat plate portion.

10. A table device comprising:
a plurality of flat plate portions configured to form a table surface and including a first flat plate portion and a second flat plate portion; and
a flat plate support mechanism supporting the first flat plate portion and the second flat plate portion in a horizontal state so that the first flat plate portion and the second flat plate portion are capable of forming a continuous table surface,
wherein the flat plate support mechanism includes a horizontal movement mechanism configured to support the first flat plate portion so that the first plate portion is horizontally movable with respect to the second flat plate portion in any direction in the horizontal state.

11. The table device according to claim 10,
wherein the horizontal movement mechanism includes a plurality of multi-directional slide mechanisms respectively corresponding to the plurality of flat plate portions, and
wherein the plurality of multi-directional slide mechanisms are mounted on a support base portion of the flat plate support mechanism, and the flat plate portions corresponding to the multi-directional slide mechanisms are mounted on the respective multi-directional slide mechanisms.

12. The table device according to claim 10,
wherein the horizontal movement mechanism includes a plurality of rotation brackets connected to a support portion of the flat plate support mechanism in a horizontally rotatable manner, and a plurality of arms whose base end portions are respectively connected to the plurality of rotation brackets in a vertically rotatable manner, and
wherein tip ends of the plurality of arms are connected to back surfaces of the corresponding plurality of flat plate portions in a vertically rotatable manner.

13. The table device according to claim 10,
wherein the horizontal movement mechanism includes a plurality of extendable and contractable arms corresponding to the plurality of flat plate portions, and
wherein, in a state in which the plurality of arms are held horizontally, base end portions of the plurality of arms are connected to a support base portion of the flat plate support mechanism in a horizontally rotatable manner, and tip ends of the plurality of arms are connected to back surfaces of the corresponding flat plate portion in a horizontally rotatable manner.

14. The table device according to claim 10,
wherein a planar shape of the table surface formed by the plurality of flat plate portions can be changed into an arbitrary shape.

15. The table device according to claim 10,
wherein the horizontal movement mechanism includes a driving source configured to horizontally move the first flat plate portion with respect to the second flat plate portion.

16. The table device according to claim 10,
wherein the horizontal movement mechanism is configured to relatively horizontally move the first flat plate portion and the second flat plate portion by applying an external force to the first flat plate portion and the second flat plate portion.

17. A table device comprising:
a plurality of flat plate portions configured to form a table surface and including a first flat plate portion and a second flat plate portion; and
a flat plate support mechanism configured to support the first flat plate portion and the second flat plate portion in a horizontal state so that the first flat plate portion and the second flat plate portion are capable of forming a continuous table surface,
wherein the flat plate support mechanism includes an angle adjustment mechanism configured to support the first flat plate portion and the second flat plate portion so that tilt angles of the first flat plate portion and the second flat plate portion with respect to a horizontal plane are capable of being individually adjusted.

18. The table device according to claim 17,
wherein the angle adjustment mechanism includes a plurality of arms respectively corresponding to the plurality of flat plate portions, and
wherein base end portions of the plurality of arms are connected to a support portion of the flat plate support mechanism in a vertically rotatable manner, and tip ends of the plurality of arms are connected to back surfaces of the corresponding flat plate portions in a vertically rotatable manner.

19. The table device according to claim 17,
wherein the flat plate support mechanism includes a plurality of support base portions respectively corresponding to the plurality of flat plate portions, and a slide mechanism provided on each of the support base portions and configured to slidably support each of the flat plate portions along each of the support base portions, and
wherein the angle adjustment mechanism is configured to adjust tilt angles of the support base portions.

20. The table device according to claim 17,
wherein the angle adjustment mechanism is configured to relatively adjust the tilt angles of the first flat plate portion and the second flat plate portion so that the first flat plate portion and the second flat plate portion overlap with each other, thereby folding the table surface.

21. The table device according to claim 17,
wherein at least one of the flat plate portions functions as a monitor, and
wherein the angle adjustment mechanism is configured to tilt one of the first flat plate portion and the second flat plate portion with respect to the horizontal plane so as to be usable as a monitor while holding another of the first flat plate portion and the second flat plate portion in the horizontal state.

22. The table device according to claim 17,
wherein the angle adjustment mechanism includes a driving source configured to adjust the tilt angles of the first flat plate portion and the second flat plate portion with respect to the horizontal plane.

23. The table device according to claim 17,
wherein the angle adjustment mechanism is configured to adjust the tilt angles of the first flat plate portion and the second flat plate portion with respect to the horizontal plane by an external force applied to the first flat plate portion and the second flat plate portion.
